(19) United States
(12) Patent Application Publication
(10) Pub. No.: US 2010/0255820 A1
(43) Pub. Date: Oct. 7, 2010

(54) Apparatus and Methods for Protection From Unintentional Phone-Dialing

(75) Inventors: John W. Maly, LaPorte, CO (US); Lisa F. Maly, LaPorte, CO (US)

Correspondence Address: Oppedahl Patent Law Firm LLC, P O Box 5940, Dillon, CO, 80435-5940, US

(73) Assignee: JOHN MALY & ASSOCIATES, INC., Nassau (BS)

(21) Appl. No.: 12/416,925

(22) Filed: Apr. 2, 2009

(51) Int. Cl. H04M 3/42

(52) U.S. Cl. 455/414.1

(57) ABSTRACT

The inventive concepts presented in this application address the problem of inadvertently dialing telephone numbers that are stored in the memory of a telephonic device, resulting in undesired calls. The database in a user's telephonic device incorporates means for flagging selected contacts for one or more calling-confirmation steps to prompt the user to ensure that an outgoing call is desired and/or appropriate. The proposed solutions encompass communication devices that use buttons, switches, dials, wheels, joysticks, track sticks, trackballs, keypads, keyboards, touchpads, touch screens, voice-recognition commands, biometric-authentication devices, other input technology, or any combination thereof. The proposed solutions also encompass wired and wireless communication device accessories.

### BACKGROUND

Since the advent of automated dialing in telephones (that is, “speed dialing”), the prospect of inadvertently dialing another party inappropriately (e.g., dialing a party at an inconvenient hour of the day, or dialing a party who, for one reason or another, should not be dialed at all) has increased. As cell phones have evolved, the possibility of inadvertent dialing of other parties has increased as the cell phones have gotten smaller. For example, “pocket calls” can be initiated by the simple bumping of a cell phone being carried within a user's pocket, as discussed, in the web article, “Perils of the Pocket Call”, Red Tape Chronicles (MSNBC), Bob Sullivan, May 9, 2008, available at http://redtape.msnbc.com/2008/05/post.html:

Fix our phones!
But this is really a hardware design flaw. It's up to cell phone makers to improve their candy bars and innovate to save us from ourselves. Apple's iPhone has a decent strategy—a small locking button on the top turns off screen-touch functionality. Unfortunately, my fashionable iPhone friends tell me they often forget to hit the lock.
How about some sensible behavior monitoring? After two or three calls to the same number in quick succession, for example, the phone could be locked until the dialer proves it's not an accident. A simple keystroke challenge (“If you are a person, type 5634” or some such) would do the trick. So would a keystroke or finger gesture that would be required to “wake” up the phone at all, like a FIG. 8. The iPhone's mandatory swipe after unlocking is a good idea.

In the above-mentioned Red Tape article, the author proposes what virtually all others in the art propose—a means of completely locking-out a phone's dialing/keyboard capability until some sort of affirmative action is completed by the user to ensure that the keyboard/dialing event is not an accident. Additionally, the above-mentioned article does not consider any discrimination between contacts that should be subjected to extra confirmation or verification features.

However, in addition to inadvertent calls that are initiated through inadvertent physical interaction with a telephonic device, inadvertent calls are often initiated through a mere mental lapse. Examples include when the user's employer is dialed from a place where the background noise might indicate facts the user might wish to keep secret, or when the telephone number of a business competitor is mindlessly dialed while thinking about an issue involving said competitor and the telephone number of a user's legal counsel was intended instead.

Of course, most users have a set of telephone numbers for which the user would not desire special calling-confirmation protections against inadvertent dialing and for which the imposition of extra security measures to allow an outgoing call to routine, trusted contacts would be considered an undue burden. Likewise, the consequences of inadvertently dialing an important business contact may be far more serious than the consequences of inadvertently dialing a friend or relative. No solutions in the art against inadvertent dialing make any mention of this consideration, let alone make an exception to confirmation or verification measures for routine, trusted user contacts, with the possible exception of emergency “911” dialing.

Many cell phone devices employ a keyboard “lock” to prevent accidental dialing. For example, some “BlackBerry” devices have a keyboard-locking capability that is disabled when depressing the roller ball on the device three times. Other similar solutions include the iPhone's “Sleep/Wake” button to disable the touch screen, which also requires that a user drag the “slider” on the touch screen after reactivation (i.e., “waking”) to ensure that the “Sleep/Wake” button was not depressed accidentally. Some cell phones, however, rely on a purely physical constraint to prevent inadvertent keyboard operations; for example the T-Mobile Sidekick Slide, “T-Mobile Sidekick LX”, and Samsung D807 each use a sliding cover that must be moved to expose the keyboard and make the keyboard available for operations. In addition, the EnGenius Durafon cordless phone family of products also feature a keyguard to prevent any inadvertent key operations. Notably, the above solutions all involved effectively completely locking-out the keypad/touchpad/touch screen from all operations.

Other proposed solutions involve the installation of software, such as “CellLock 1.4” (freeware produced by MindWarrior), which is used to completely deactivate a keyboard or touch screen until the designated “Unlock” button is pressed and a confirmation password is entered to unlock the entire keypad/touchpad/touch screen. Similarly, the Elecont Dialer (phone-dialer software for Windows Mobile) employs a comparable scheme to prevent accidental clicks on a keyboard/touchpad/touch screen. Smart Dialer 2.1 software by Netcom, intended for Pocket PC Windows Mobile 5.0, has a feature to switch-off the device upon call completion as a way to prevent accidental redial.

For many of the existing solutions involving a keypad/touchpad/touch screen lock, there is further the problem of receiving phone calls while the cellular telephone is in the locked mode. In most examples, to receive a phone call, the user simply answers the call as if the cell phone was in standby mode. However, upon termination of the call, the cell phone immediately reverts to the locked mode. After receiving a phone call, it is not unusual for a user to desire to make another phone call based on the discussion he or she just had. Since the cellular telephone is in the locked mode, the user must go through the steps to switch the phone to active mode. For many users, such a blanket lock-out policy within the phone simply is neither needed nor desired to guard against trusted, commonly called contact telephone numbers.

Predictably, makers of cell phones for young children have thought about the problem of accidental dialing. For example, Verizon's Migo cell phone is deliberately designed to allow the dialing of only a few telephone numbers entered into memory (presumably by parents) and to require two key presses for each call to guard against accidental dialing. To dial an emergency number, the call button must be held down for several seconds to guard against accidentally dialing 911 or the like.

Some have patented or applied for patent protection for inventions that included solutions to prevent accidental calling of telephone numbers. Some of these proposed solutions also encompass voice-dialing.

For example, U.S. Patent Application Publication No. 2007/0286398 A1 to Ramamoorthy et al., “Voice Recognition Dialing for Alphabetic Phone Numbers”, discloses that the user initiating the voice-dialing may be prompted in some embodiments to repeat the telephone number; however, that type of verification simply lends itself to allow a user to simply repeat the telephone number without a calling-confirmation step to ensure that the user is actually aware of the party being dialed associated with that telephone number. Further, in very noisy environments such as motorcycle helmet phones, which must contend with wind noise, environmental noises may make it difficult for the user to hear the confirmation words that make up a spoken name, especially in systems wherein the spoken name is synthesized (often badly) by an automated speech-synthesis agent. Thus, the other approaches do not present a comprehensive solution for preventing or discouraging improperly recognized voice dials to important contacts.

Some in the art proposed to make use of intelligent call completion schemes to decrease the chance of wrong telephone numbers being dialed. See, for instance, U.S. Patent Application Publication No. 2006/0068786 to Florence, “Dialing services on a mobile handset and remote provisioning therefore”, and U.S. Pat. No. 7,455,304 to Porter, “Telephone quick dialing and re-dialing”. However, these types of solutions do not address the problem where there is no mis-entry of the format of an entered telephone number but where the user is in need of a mental prompt to ensure that certain parties are not inadvertently called.

U.S. Patent Application Publication No. 2006/0068786 to Yu, “Method and apparatus for automatically deactivating a keypad lock”, proposes allowing the deactivation of the locking of a keypad by employing the detection of time delays between attempted key presses to determine whether a given key press is likely to be an inadvertent keying event. This solution also only involves a situation where a telephonic device's keypad/touchpad/touch screen is either locked or unlocked for all inputs. U.S. Patent Application Publication No. 2006/0030367 to Cowsky et al., “Method and apparatus for protecting against an inadvertent keystroke”, also discloses the detection of time by detecting if a key remains depressed for a predetermined amount of time, and if so, keeping the phone in a standby, locked mode. Cowsky goes on to disclose that the keyboard can be re-enabled immediately after receiving a call, and the user may subsequently provide the proper response in answer to a visual prompt to re-enable to the keypad after completion of the incoming call.

Another approach which addresses the inadvertent dialing of telephone numbers is proposed by U.S. Pat. No. 6,662,026 to Cordray et al., “Apparatus and Method for Detecting and Handling Accidental Dialing on a Mobile Communication device”. Cordray proposes monitoring outgoing and incoming voice levels in order to detect an absence of conversation in both directions for a specified period of time, after which the call is terminated. This approach does not come close to addressing the problem of preventing such inadvertent telephone calls in the first place.

In all of the disclosures mentioned above, and myriad similar disclosures in the art, none address the goal of providing a way to discriminately provide an additional layer of protection against inadvertently dialing certain telephone numbers stored in the contacts database stored onboard a user's telephonic device (most typically a cellular phone), while not providing said additional layer of protection with regard to the dialing of certain, trusted or close contact telephone numbers.

### BRIEF SUMMARY

The present inventive concepts presented in this application are generally directed to the problem of inadvertently initiating a call or dialing telephone numbers that are stored in the memory of a telephonic device, resulting in undesired completed calls. Most often, this problem is experienced with cellular phones or similar communication devices because of the fact that users typically store many contact telephone numbers within the telephonic device's database, often with many numbers set up for speed dialing. Even for numbers not setup for speed dialing, many users need to be prompted to perform some sort of affirmative step to ensure that a dialed outgoing call is not a mistake, because of the potential adverse consequences of allowing such a call to go through at a given inopportune time and/or to an inappropriate party. At the same time, users need flexibility in their communications system such that they can conveniently call trusted and/or frequently called contacts without having to go through one or more calling-confirmation or verification steps.

In one embodiment, a database of contact telephone numbers contained in a user's cell phone will include a flag for one or more contact entries to indicate whether dialing a particular contact should be subjected to one or more additional outbound-call confirmation steps to prevent an inadvertent or unintentional call. Other, non-flagged contacts (such as personal contacts) can remain “unlocked”; that is, no additional calling-confirmation to protect the user from calling those non-flagged contacts is provided. In an embodiment for those contacts flagged for one or more calling-confirmation steps, said one or more calling-confirmation steps requires a keystroke combination/confirmation step before a prospective outgoing call may be completed.

In one embodiment, this calling-confirmation step includes an operation as simple as prompting the user with the question, “Are you sure? (Y/N)”, to which the user enters “Yes” or “No”, or presses one or more buttons signifying the affirmative or negative. In another embodiment, the calling-confirmation step includes prompting the user to speak the word “Confirmed,” or other word or group of words. In still another embodiment, this calling-confirmation step includes prompting the user to simultaneously press a fixed or random combination of keys, to enter a fixed or random sequence of keys, to speak one or more fixed or random numbers, letters, or words, or any combination thereof.

In another embodiment, this calling-confirmation step includes prompting the user to enter a confirmation code; to speak a confirmation word; to speak a phrase; to speak a numeric sequence; to actuate a graphical user interface element on a touch screen interface; to actuate a biometric-authentication device (e.g., a fingerprint reader, hand-measurement device, retinal scanner, etc.); to actuate a physical control such as a switch, button, dial, wheel, joystick, track stick, or trackball; or any combination of the above. One skilled in the art will appreciate that any speech recognition associated with the recognizing the speech inputs discussed herein may be performed locally by a communication device and/or an associated accessory or peripheral, or remotely by a speech-recognition agent on a remote server or by other remote communications infrastructure.

Importantly, it should be noted that the principles behind each of the systems and methodologies disclosed herein can generally be applied to communication devices and telephonic dialing systems that are based on buttons, switches, dials, wheels, joysticks, track sticks, trackballs, keypads, touchpads, touch screens, voice-activated systems, biometric-authentication devices, or other inputs, or any combination thereof. In addition, the principles behind each of the systems and methodologies disclosed herein can generally be applied to communications accessories which allow the configuration or initiation of communications calls alone, or in conjunction with another communication device.

### BRIEF DESCRIPTION OF THE DRAWINGS

FIG. 1 depicts one embodiment of a system for detecting and preventing an unintentional outgoing communications call.

FIG. 2 depicts the operational flow of the operations performed in accordance with one embodiment of the claimed invention.

FIG. 3 depicts the operational flow of the operations performed in accordance with one embodiment of the claimed invention.

### DETAILED DESCRIPTION

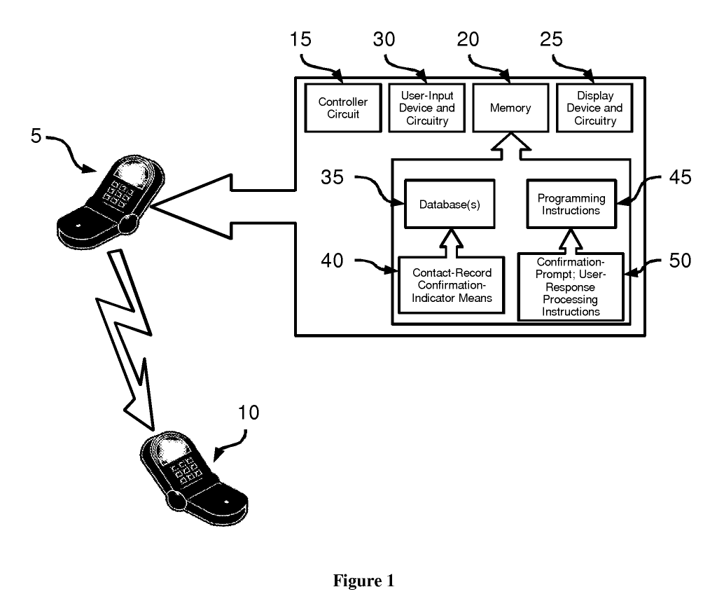

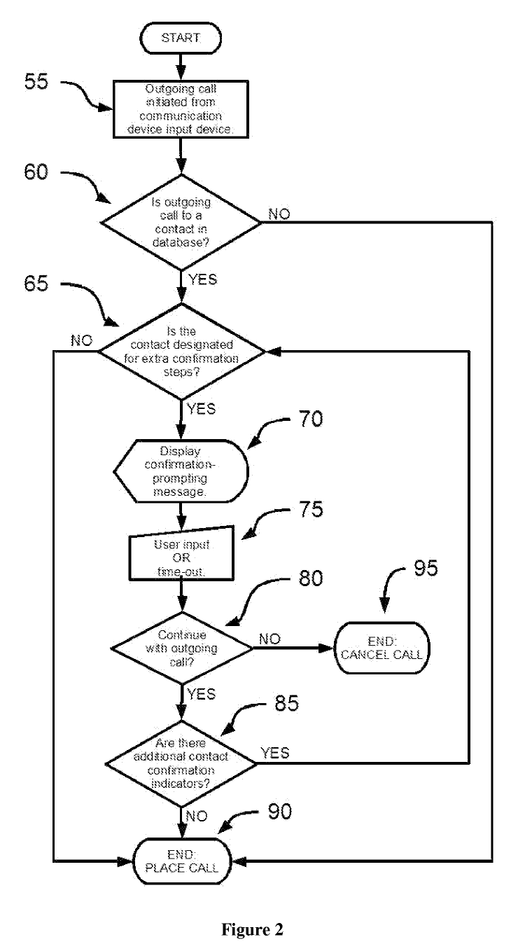

Refer to FIGS. 1 and 2. One exemplary embodiment of the claimed invention is generally directed to the problem of inadvertently dialing telephone numbers that are stored in the memory of a telephonic device, resulting in undesired completed calls. Most often, this problem is experienced with cellular phones or similar communication devices because of the fact that users typically store many contact telephone numbers within the telephonic device's database, often with many numbers set up for speed dialing. Even for numbers not setup for speed dialing, many users need to be prompted to perform some sort of affirmative step to ensure that a dialed outgoing call is not a mistake, because of the potential adverse consequences of allowing such a call to go through at an inopportune time and/or to an inappropriate party. At the same time, these users need the flexibility in their communication system such that they can conveniently call trusted and/or frequently-called contacts without having to go through one or more calling-confirmation steps.

### Designating Certain Contacts for Extra Calling-Confirmation Steps

In one exemplary embodiment, a database (35) of contact telephone numbers stored in the memory (20) of a user's communication device (5) includes a means to designate certain contact entries (40) to be subjected to one or more outbound-call confirmation steps to prevent an inadvertent call (50). Other, non-designated contacts (such as personal contacts) can remain “unlocked”; that is, no extra calling-confirmation to protect the user from calling those non-flagged contacts is provided. Several different strategies can be employed to designate one or more contact records for one or more calling-confirmation steps. For example, a database of contact records (35) can include a data field, Boolean, bit-flag character, column, object, or other data element to act as a “flag” (40) to designate a given record for one or more calling-confirmation steps.

In an alternative embodiment, a separate calling-confirmation database table (35) with a subset of contact records represented in the main contact database (35) that stores contact records can be used, wherein the contact records listed in the separate calling-confirmation database table are contact records required to be subject to one or more calling-confirmation operations before allowing an outgoing call to the associated contact to be dialed to initiate a call attempt.

In another alternative embodiment, a separate calling-confirmation database table (35) with a subset of contact records represented in the main contact database (35) that stores contact records can be used, wherein the contact records listed in the separate calling-confirmation database table (35) are contact records that are not subject to one or more calling-confirmation operations before allowing an outgoing call to the associated contact to be dialed to initiate a call attempt.

In yet another embodiment, the user is given the ability, through the user's communication device, to configure one or more contact records for desired calling-confirmation status (40). In a further embodiment, the user is prompted to confirm desired changes to a contact's calling-confirmation configuration before a change is committed by the system.

### Implementation of One or More Calling-Confirmation Steps

In one embodiment, for outgoing calls to those contacts designated for one or more calling-confirmation or verification steps (40), the programming of the user's communication device (45) causes the user to be visually prompted (50) (70) with a message and/or some other visual prompt (50) (70) on the communication device's display (25) (70). In another embodiment, an audio prompt (50) can be used to prompt the user with a confirmation request. In still another embodiments, a visual prompt (50) (70) can be accompanied by an audio prompt (50). The prompt requires the user to acknowledge the prompt in some way, such as by providing an affirmative entry (30) (75) of some sort of confirmation input to confirm the user's desire to make the outgoing call—that the prospective outgoing call is a valid and appropriate attempt by the user to complete the call. In one embodiment, the user can also enter (30) (75) a negative response or other escape sequence to cancel the call. However, if the user provides no recognized response to the prompt then the call may be automatically canceled. In another embodiment, if the user provides no recognized response to the prompt within a predetermined/programmed period of time, then the call may be automatically canceled.

In one embodiment, if the user enters an unrecognized response, the user may be prompted to re-attempt to enter a calling-confirmation input. In a further embodiment, the user may be given one or more options, such as to cancel the call attempt, or to re-attempt to enter a calling-confirmation input.

In an embodiment, the user may be required to perform additional calling-confirmation steps for a given contact. This extra level of protection can be used for particularly important business contacts. Alternatively or additionally, this extra level of protection can be used to enable the communication device to attempt to “talk the user out of” calling an ex-girlfriend or ex-boyfriend, or other individual that the user previously identified for extra protection through the use of multiple confirmation prompts (e.g., an “Are you sure?” prompt, followed by “Are you really, absolutely sure?” if the user answered affirmatively to the first prompt).

Of course, if a dialed contact is not designated for one or more calling-confirmation steps, then the system permits the outgoing call to be attempted as it normally would, without said one or more calling-confirmation steps.

In one embodiment, the communication device's programming instructions (45) can cause the disabling of any speed-dialing capability associated with a contact designated for one or more calling-confirmation steps. In a further embodiment, this disabling of the speed-dialing for the selected contact may be subjected to a user-specified time period or limit, after which the speed-dialing capability for the contact is re-enabled.

### Types of User Confirmation-Response Entries

The types of entries of calling-confirmation input (30) (75) received from the user in answer to the calling-confirmation prompt (50) (70) will vary as a function of the type of user interface (30, 25) for the communication device. For communication devices that rely primarily on keypad, keyboard, touchpad, or touch screen entry, the user response to enable an outgoing call can require a specific calling-confirmation code, such as an alpha-numeric password, alpha-numeric phrase, swipe of a touchpad, or actuation of a graphical user interface element such as a slider bar. In one embodiment, the user entry can require the simultaneous pressing of at least two-keys and/or buttons, the combination of which may involve two keys or buttons that are not proximal to each other to ensure that the simultaneous pressing is deliberate. In another embodiment, a similar scheme could be applied for a touch screen or touchpad, wherein one or more of the at least two keys or buttons in the combination press are graphical in nature.

In an embodiment involving a touch screen, the user input (75) required to enable an outgoing call subjected to one or more calling-confirmation steps can require that the user provide an affirmative indication and/or negative indication of user intent by way of depressing a button or other mechanical control element on the communication device, followed by the user's manipulation of a graphical user interface control element on the touch screen, thus combining one or more graphical “virtual” control elements with one or more mechanical control elements.

In another embodiment, user input for dialing can be by way of speech-recognition dialing; therefore, the user input (75) to respond to the calling-confirmation prompt (50) (70) may also be by way of speech recognition of voice commands, or by way or a combination of voice commands and the deliberate actuation of a mechanical control element or graphical-control element. Further, the user may provide the confirmation-response input (75) by way of a second wireless-input device, such as a Bluetooth device.

In one embodiment, the user can designate one or more contacts as belonging to one or more categories. Exemplary categories may include, but are not limited to, “Personal,” “Business,” “Family”, “Friends,” “Important,” “VIP,” “Long Distance,” “Local,” “International,” “Domestic,” “In My Plan,” “Not in My Plan,” etc. In another embodiment, the user can designate one or more individual numbers associated with a contact as belonging to one or more categories. Exemplary categories may include, but are not limited to, “Home,”, “Cellular,” “Mobile,” “Work,” “Office,” etc. In one embodiment, a given contact or number may belong to a plurality of categories at a given time. In another embodiment, a given contact may belong to only as many as one category at a given time. Using categories, calling confirmation can then be globally activated or deactivated by the user for an entire category of contacts and/or numbers. For example, when the user leaves work at 5:00 PM on a Friday evening, he or she may turn on calling confirmation for all users belonging to the “Business” category, but leave calling confirmation off for all users belonging to the “Personal” category. In another example, the user may activate calling confirmation for the “Long Distance” category of numbers, that is, the category containing all contacts to whom calls from the communication device are not free.

In another embodiment, a time-period specification may be received from the user which specifies times during the day or week wherein calling confirmation is automatically required for a given contact or number, or a given group/category of contacts or numbers. This allows certain contacts or types of contacts (e.g., business contacts) to require one or more calling-confirmation steps outside of certain hours (e.g., business hours). The time-period specification may be used in one or more of a variety of ways. In one exemplary embodiment, a time-period specification is used to automatically activate the requirement for one or more calling-confirmation steps during a specified time period. In another exemplary embodiment, a time-period specification is used to automatically deactivate the requirement for one or more calling-confirmation steps during the specified time period. In yet another exemplary embodiment, a time-period specification is used to automatically activate the requirement for one or more calling-confirmation steps outside of the specified time period. In still another exemplary embodiment, a time-period specification is used to automatically deactivate the requirement for one or more calling-confirmation steps outside of the specified time period.

In one embodiment, the user can simultaneously enable and/or disable calling confirmation for a plurality of contacts by changing the mode of operation of the communication device. This may be accomplished by actuating a mechanical control element or a sequence thereof, and/or manipulating a graphical-control element, and/or inputting an audio command. This type of “global” control allows quick behavior changes to allow for situations which are especially conducive to unintentional calls (e.g., the user is going on a hike where a bump-dial is especially likely, the user is going on a motorcycle ride wherein poor voice-dialing is likely because of a high degree of wind noise in the user's motorcycle helmet, etc.). In an embodiment, a calling-confirmation code or other calling-confirmation step is required to simultaneously enable and/or simultaneously disable calling confirmation for a plurality of contacts.

### A System for Detecting and Preventing an Inadvertent Outgoing Communications Call

Referring again to FIGS. 1 and 2, an exemplary embodiment encompasses a system for detecting and preventing an inadvertent outgoing communications call initiated from a communication device (5); said communication device comprising an onboard controller circuit (15), memory for storing contact information (20), including contact names and telephone numbers (optionally, additional data may be stored, such as an address associated with a contact, geographic location data associated with a contact, or other data, or a combination of one or more of the above), a display device (25), and a user-input device (30); the system comprising at least one database (35) stored in said memory (20) containing at least one contact record, said record having at least one associated confirmation-indicator (40) to indicate whether a given contact record should be subject to one or more calling-confirmation steps before allowing an outgoing call to the associated contact, and programming instructions stored on a computer-readable medium to be executed by said controller circuit such that when a user attempts to initiate a call to a stored contact or stored contact telephone number, and such that if said stored contact or stored contact telephone number has an associated confirmation-indicator, then a confirmation-prompting message is presented to said user, and wherein said user is required to enter an affirmative indication to enable said attempted outgoing call to be actually dialed.

In one embodiment, programming instructions (45) are stored on a computer-readable medium to be executed by said controller circuit (15) such that when a user attempts to initiate a call (55) to a stored contact or stored contact telephone number (60) selected from said first communication device (5), and such that if said stored contact or stored contact telephone number has an associated confirmation-indicator (40) (65) indicating that one or more calling-confirmation steps is required to allow the outgoing call to be placed, then said display device (25) displays a calling-confirmation-prompting message (50) (70) to said user, wherein said calling-confirmation-prompting message (50) (70) conveys to said user a need to verify that said attempted outgoing call is a valid and appropriate or otherwise desirable attempt to call said selected stored contact or stored contact telephone number. In an embodiment, the user is required to enter (30) (75) an affirmative indication (50) (80) according to said calling-confirmation-prompting message (50) (70), and a predetermined or randomly-generated calling-confirmation response (50) (80) to enable said attempted outgoing call to be actually dialed (90), and wherein if said user enters (30) (75) a negative indication according to said confirmation-prompting message (50) (80) and a predetermined calling-confirmation response (50) (80) or if said user fails to respond to said calling-confirmation-prompting message (50) (70) (within a predetermined period of time (75) in one embodiment, or fails to respond at all, in an alternative embodiment), then said attempted outgoing call is cancelled (95). In another embodiment, if said stored contact telephone number has an associated calling-confirmation indicator (40) indicating that no calling confirmation is required to allow the outgoing call to be placed (65), or if said user provides an affirmative response to said calling-confirmation-prompting message, then said attempted outgoing call is allowed to proceed (and assuming connectivity, reception, network authentication, or other conditions sufficient to place a call as known in the art are met, placed to said selected contact's communication device (10) (95)).

In another embodiment, said confirmation-prompting message (50) (70) comprises an audio alert such as a buzzing sound, a beeping sound, an audio tone, a spoken warning, a musical interlude, or other audio output which may be generated on the communication device, or a combination of one or more of the above. In still another embodiment, the confirmation-prompting message (50) (70) comprises a visual alert combined with such an audio alert.

In an embodiment, said user-input device comprises one or more controls selected from the group consisting of buttons, switches, dials, wheels, joysticks, track sticks, trackballs, keypads, touchpads, touch screens, voice-activated systems, and biometric-authentication devices.

In another embodiment, said user-input device is a keypad and said affirmative indication is entered by said user by way of at least one keypad entry.

In another embodiment, said user-input device is a touchpad or touch screen and said affirmative indication is entered by said user by way of user's manipulation of a graphical control on said touch screen.

In another embodiment, said user-input device is a speech-recognition device and said affirmative indication is entered by said user by way of providing at least one voice command.

In another embodiment, said one or more calling-confirmation steps for contact records or contact records with an associated confirmation indicator is automatically enabled when speech-recognition dialing is being used.

In another embodiment, said one or more calling-confirmation steps for contact records or contact records with an associated confirmation indicator is automatically enabled when said user is connected to said communication device by way of a separate wireless-input device.

In an embodiment, the user can customize at least one contact record by configuring said at least one associated calling-confirmation indicator (40) for a contact record. This configuration may comprise a wide variety of user interface options, including a graphical user interface (e.g., checkbox, menu option, radio button, or other graphical user interface element).

In one embodiment, said user is prompted (50) to confirm said customization of a given contact record's said at least one associated confirmation-indicator (40).

In a further embodiment, said programming instructions (45) allow said user to control whether all said calling confirmation of outgoing calls for contact records with an associated confirmation indicator (40) is enabled or disabled by entering a predetermined confirmation code. Alternatively, said programming instructions (45) allow said user to control whether all said calling confirmation of outgoing calls for contact records with an associated confirmation indicator (40) is enabled or disabled by entering a randomly generated confirmation code (i.e., the communication device presents a randomly generated sequence of numbers, letters, or words to be input into the communication device, or spoken aloud, to enable the attempted call to proceed).

In another embodiment, said at least one associated confirmation-indicator for said at least one contact record comprises a flag that indicates to said programming instructions whether a given contact record should be subject to one or more calling-confirmation steps before allowing an outgoing call to the associated contact to be dialed to initiate a call attempt.

In another embodiment, said at least one associated confirmation-indicator for said at least one contact record comprises a confirmation database table with a subset of contact records represented in said at least one database.

One skilled in the art will appreciate that relevant contact data, customized confirmation-configuration data, or other data may be stored on a detachable memory card, media card, or remote server without departing from the scope of the claimed embodiments.

### A Method for Preventing an Unintentional Outgoing Communications Call

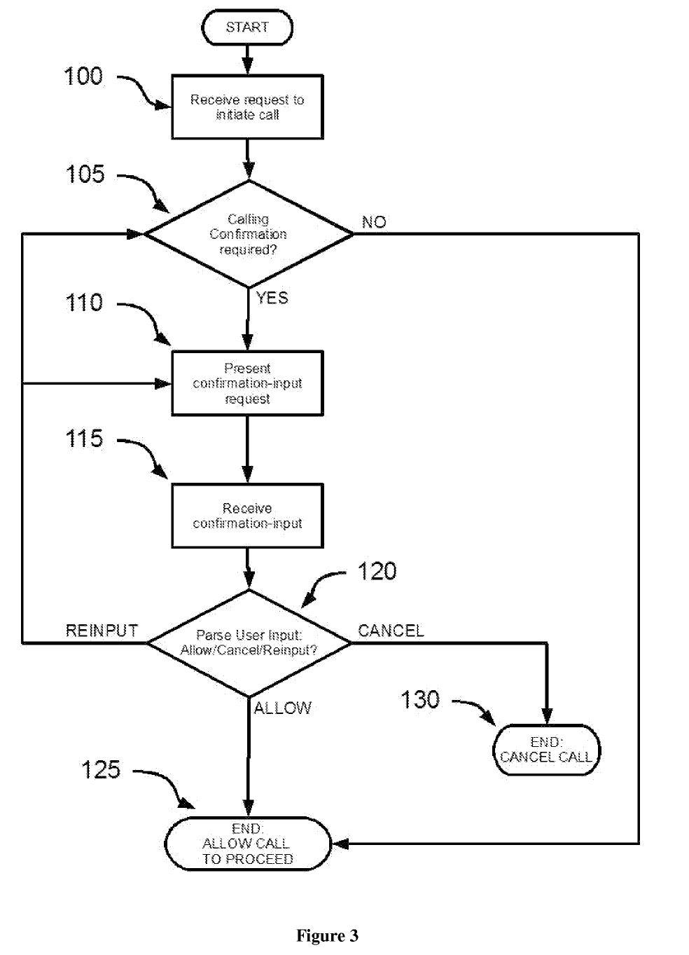

FIG. 3 illustrates the operational flow of the operations performed in accordance with one embodiment of the claimed invention in which a communications call is processed to prevent an unintentional outgoing communications call initiated from a communication device. A receive operation (100) receives a request from a user to initiate a communications call to a given contact. In one embodiment, the request is received directly by the communication device (e.g., by the dialing of a phone number, by the dialing of *69 or other dialing code which attempts to call the last number that called the communication device, by the selection a phone number, by the selection of contact from an address book, by the selection of a contact or phone number from a call log or other list of recently dialed calls, etc.). In another embodiment, the request is received using a communication device accessory such as a wireless interface which allows the initiation of calls in conjunction with the communication device.

A determine operation (105) then determines whether calling confirmation is required for the selected contact (that is, the contact to which the user has initiated the communications call). In one embodiment, the determine operation (105) checks a database of contacts to check whether the selected contact is flagged for calling confirmation. In another embodiment, the determine operation (105) checks a database containing a subset of contacts to determine whether or not a given contact is flagged for calling confirmation.

If the determine operation (105) determines that calling confirmation is not required for the selected contact, then flow branches NO to an allow-call operation (125). The allow-call operation (125) then allows the communications call to proceed as it normally would on the communication device. In one embodiment, the communications call would be placed, dialed, or otherwise initiated. In another embodiment, additional other operations known in the art may be required before initiation of the communications call. Alternatively, if the determine operation (105) determines that calling confirmation is required for the selected contact, then flow branches YES to a present-confirmation operation (110).

If the determine operation (105) determined that calling confirmation is required for the selected contact, then the present-confirmation operation (110) presents a confirmation-input request (110) to the user. In one embodiment, the confirmation-input request (110) indicates that confirmation is required for the selected contact by displaying a message to that effect on a text display of the communication device. In another embodiment, the confirmation-input request (110) indicates that confirmation is required for the selected contact by displaying a message and/or a video sequence to that effect on a graphical display of the communication device. In still another embodiment, the confirmation-input request (110) indicates that confirmation is required for the selected contact by playing an audio message to said effect on the speakers, headphones, or earbuds of the communication device, and/or on speakers, headphones, or earbuds located remotely from the device which are associated with a wired or wireless communications accessory. In one embodiment, the confirmation-input request (110) indicates a predetermined code which may be received from the user to allow the call to proceed. In another embodiment, the confirmation-input request (110) indicates a randomly generated sequence of inputs that may be received from the user to allow the call to proceed.

A receive-confirmation operation (115) (120) then receives a proper confirmation input before allowing the call to proceed (125). In one embodiment, the received input comprises one or more inputs from the communication device, such as a button press, a key press, a switch actuation, actuation of a dial, actuation of a wheel, actuation of a joystick, actuation of a track stick, actuation of a trackball, actuation of a graphical-control element in a graphical user interface, actuation of a biometric-authentication device, activation of a touchpad, activation of a touch screen, a spoken word or phrase or other vocalized sound, or any sequence or combination of one or more inputs such as these. In one embodiment, if an incorrect confirmation input is received (120), the receive operation (115) invites the user to try again. This may be accomplished by branching back to the determine operation (105), or branching back to the present operation (110), or by presenting a new confirmation-input request indicating that the entered confirmation input was incorrect. In an embodiment, the receive operation (115) (120) is capable of receiving a call-cancellation request which cancels the calling attempt (130).

If the receive operation (115) (120) receives a proper confirmation input, then the allow-call operation (125) then allows the communications call to proceed as it normally would on the communication device.

### OTHER EMBODIMENTS AND VARIATIONS

One skilled in the art will appreciate that embodiments of the claimed technology can be applied to many different types of telephonic/communication devices such as cellular telephones, cordless telephones, vehicular communications systems, PDAs, smartphones, Bluetooth or other wireless or wired phone-dialing devices, video phones, Voice-Over-IP (VOIP) communication devices (such as a Skype phone), or other Internet phone technology, and any other present or future portable communication device capable of initiating a communication event to the owner or user of a remote communication device. Moreover, the principles underlying the embodiments disclosed herein can be applied to outgoing calls initiated from a button, switch, dial, wheel, joystick, track stick, trackball, keypad, touchpad, touch screen, voice-based dialing system, biometric-authentication device, or other input technology. Furthermore, it is probable that the principles underlying this embodiment can be applied to future communication devices that employ new means to initiate outgoing calls.

The various embodiments described herein are provided by way of illustration only and should not be construed to limit the scope of the inventive concepts discussed. Those skilled in the art will readily recognize various modifications and changes that may be made to the present invention without following the example embodiments and applications illustrated and described herein, and without departing from the true spirit and scope of the present invention, which is set forth and intended to be encompassed within the scope of the following claims.

1. A method for preventing an unintentional outgoing communications call initiated from a communication device, said method comprising the steps of:
by said device, receiving a request from a user to initiate said call to a contact;
by said device, determining whether calling confirmation is required for said contact;
if calling confirmation is required for said contact, by said device, presenting a request to said user for entry of a confirmation input into said device, and requiring said confirmation input from said user to be received by said device before allowing said call.

2. A method as defined in claim 1, wherein said request for confirmation input further comprises displaying a request for a confirmation input on a display device of said communication device.

3. A method as defined in claim 1, wherein said request for confirmation input further comprises an audio alert.

4. A method as defined in claim 1, wherein if said calling confirmation is required for the contact, said communication device disables a speed-dialing feature associated with said contact.

5. A method as defined in claim 1, wherein said calling confirmation is automatically required for the contact when speech-recognition dialing is being used.

6. A method as defined in claim 1, wherein said calling confirmation is automatically required for said contact when said user is connected to said communication device by way of a separate wireless-input device.

7. A method as defined in claim 1, wherein said calling confirmation is automatically required for said contact during certain times of the day.

8. A method as defined in claim 1, further comprising the step of allowing said user to simultaneously enable and disable calling confirmation for a plurality of contacts.

9. A method as defined in claim 1, further comprising the step of allowing said user to designate one or more contacts as belonging to a category, and wherein said calling confirmation may be simultaneously enabled or disabled for said one or more contacts belonging to said category.

10. A system for detecting and preventing an inadvertent outgoing communications call initiated from a communication device; said communication device comprising an onboard controller circuit, memory for storing contact information, including contact names and telephone numbers, a display device, and a user-input device; the system comprising:
at least one database stored in said memory containing at least one contact record, said contact record having at least one associated confirmation-indicator to indicate whether a given contact record should be subject to one or more calling-confirmation steps before allowing an outgoing call to the associated contact; and
programming instructions stored on a computer-readable medium to be executed by said controller circuit such that when a user attempts to initiate a call to a stored contact telephone number, and such that if said stored contact telephone number has an associated confirmation indicator, then a confirmation-prompting message is presented to said user,
wherein said user is required to enter an affirmative indication to enable said attempted outgoing call to be actually dialed.

11. A system as defined in claim 10, wherein said confirmation-prompting message is presented to said user using said display device.

12. A system as defined in claim 10, wherein said confirmation-prompting message is presented to said user by way of an audio alert.

13. A system as defined in claim 10, wherein said user-input device comprises one or more controls selected from the group consisting of buttons, switches, dials, wheels, joysticks, track sticks, trackballs, keypads, touchpads, touch screens, voice-activated systems, and biometric authentication devices.

14. A system as defined in claim 10, wherein said user-input device is a touch screen, and wherein said entered affirmative indication comprises said manipulation of a graphical control on said touch screen.

15. A system as defined in claim 10, wherein said user-input device employs speech-recognition, and wherein said entered affirmative indication comprises said user providing at least one voice command.

16. A system as defined in claim 10, wherein said one or more calling-confirmation steps for contact records with an associated confirmation indicator is automatically enabled when speech-recognition dialing is being used.

17. A system as defined in claim 10, wherein said user can customize at least one contact record by configuring said at least one associated confirmation indicator associated with said at least one contact record.

18. A system as defined in claim 10, wherein said at least one associated confirmation indicator for said at least one contact record comprises a flag that indicates to said programming instructions whether a given contact record should be subject to one or more calling-confirmation steps before allowing an outgoing call to the associated contact to be dialed to initiate a call attempt.

19. A system as defined in claim 10, wherein said at least one associated confirmation indicator for said at least one contact record comprises a confirmation database table with a subset of contact records represented in said at least one database.

20. A computer-readable medium for use with a communication device, said medium comprising at least one program for preventing an unintentional outgoing communications call initiated from a communication device, said at least one program comprising:
the capability of causing said device to be able to receive a request from a user to initiate an outgoing communications call to a contact;
the capability of determining if calling confirmation is required for said contact and if so, then
causing said device to present a request for a confirmation input to said user, and
causing said device to require said confirmation input from said user to be received by said device before allowing said call.
